(19) United States
(12) Patent Application Publication
(10) Pub. No.: US 2009/0208811 A1
(43) Pub. Date: Aug. 20, 2009

(54) Fuel Cell Cartridge Connector

(76) Inventor: Yasuaki Nakamura, Shizuoka (JP)

Correspondence Address: TROJAN LAW OFFICES, 9250 WILSHIRE BLVD, SUITE 325, BEVERLY HILLS, CA, 90212, US

(21) Appl. No.: 12/373,029

(22) PCT Filed: Jun. 6, 2007
(86) PCT No.: PCT/US07/70503

§ 371 Date: Jan. 8, 2009

(30) Foreign Application Priority Data
Jul. 12, 2006 (JP) JP2006-191162

(51) Int. Cl. H01M 2/00

(52) U.S. Cl. 429/34

(57) ABSTRACT

The problem to solve is providing a fuel-cell cartridge connector that protects the fuel-cell-holding appliance from damage when a external force which exceeds the allowable range, is applied to the fuel cell cartridge. To solve the problem a fuel-cell connector (1) is provided, comprising: an outwardly facing fuel supply opening (12a) provided on one end of a fuel-cell cartridge body (31) that has a fuel-cell chamber (311) for containing a fuel F to be supplied to the fuel-cell cartridge (3) and a connecting projection member (11c) that surrounds the aforementioned fuel-supply opening (12a); said fuel cell connector (1) being intended for releasable connection to an appliance (4) that contains the fuel cell, has an outwardly facing fuel-receiving opening (2a) for receiving fuel F and has a connection portion (2) that corresponds to the aforementioned connecting projection member (11c), the fuel-cell connector (1) being characterized by a provision of at least one or more structures out of a plurality of such structures which are breakable from the aforementioned fuel-cell chamber (311) at a predetermined distance therefrom and out of a plurality of disconnectable structures which can be separated from the connection portion (2) when the connecting projection member is connected to the connection portion so that the fuel-receiving opening communicates with the fuel-receiving opening and when an external force that exceeds a predetermined value is applied to the fuel-cell cartridge (3).

### FIELD OF THE INVENTION

The present invention relates to a fuel-cell cartridge connector, and, more particularly, to a structure for connection to a fuel-cell-using appliance.

### BACKGROUND OF THE INVENTION

A fuel cell is known in the art as an energy-conversion device in which hydrogen ions pass through an electrolyte membrane that separates oxygen from hydrogen, methanol, or a similar fuel, whereby the chemical reaction that occurs between hydrogen and oxygen generates electricity. At the present time, fuel cells have found some practical applications since it is expected that operational temperature may be low and that the device can be reduced in size. Developments have been carried out in the direction of fuel-cell use as electrical power sources for long-lasting and continuous operation of note-book-type computers and various portable devices such as mobile phones.

Normally, a fuel cell that is used as a power source of a mobile device is built into this device, and when the fuel contained in such a source is exhausted, it can be replenished by a new portion of fuel for direct conversion into electrical energy. The aforementioned built-in fuel cells are filled with fuel by means of fuel containers (fuel-cell cartridges) (see Japanese Unexamined Patent Application Publication (Kokai) 2006-54055).

### DESCRIPTION OF THE INVENTION

The aforementioned fuel-cell cartridges may be of the following types: an insert type fuel-cell cartridges which are incorporated into fuel-cell holding appliances; a satellite type fuel-cell cartridges which are connected to a connection portion of the appliance that has a space for retaining the fuel, the cartridge being connected to the appliance from outside and only at a time of replenishment of the fuel; an attachment type fuel-cell cartridges which are attached from the outside to a connection portion of an appliance and are used as they are in the appliance-attached state; and an exterior type which are used similar to the fuel-cell cartridges of the attachment type but match to their design as a decorative item.

Since the fuel-cell cartridges of a design type, attachment type, and exterior type need to be removably and rigidly connected to the fuel-cell holding appliances, the connection portions of the fuel-cell cartridges and fuel-cell holding appliances should be sufficiently strong to withstand forces applied to these portions at the time of connection and disconnection.

However, when an external force that exceeds a value specified for normal operation, i.e., the force that goes beyond a specified range or that can damage the parts of the fuel cartridge, is applied to a fuel-cell cartridge, the aforementioned connection portion [of the appliance] can be broken, and since normally a fuel-cell-holding appliance is much more expensive than the fuel-cell cartridge itself, it is desirable to protect parts of the appliance from damage.

Keeping the above information in mind, it is an object of the present invention to provide a fuel-cell cartridge connector that is strong enough to withstand a normal operation force and that protects, due to the use of a breakable and/or disconnectable elements, the fuel-cell-holding appliance from damage or breaking by a force that is beyond a normally allowable range.

The fuel-cell-cartridge connector of the present invention comprises:

an outwardly facing fuel supply opening provided on one end of a fuel-cell cartridge body that has a fuel-cell chamber for containing a fuel to be supplied to the fuel-cell cartridge and a connecting projection member that surrounds the aforementioned fuel-supply opening; said fuel cell connector being intended for releasable connection to an appliance that contains the fuel cell, has an outwardly facing fuel-receiving opening for receiving fuel and has a connection portion that corresponds to the aforementioned connecting projection member, the fuel-cell connector being characterized by a provision of at least one or more structures out of a plurality of such structures which are breakable from the aforementioned fuel-cell chamber at a predetermined distance therefrom and out of a plurality of disconnectable structures which can be separated from the connection portion when the connecting projection member is connected to the connection portion so that the fuel-receiving opening communicates with the fuel-receiving opening and when an external force that exceeds a predetermined value is applied to the fuel-cell cartridge.

In the context of the present invention, the term “an external force that exceeds a predetermined value” means a force that is different from one used at normal use and goes beyond the scope of the specified range or damages the parts.

In the fuel-cell cartridge connector of the invention, the aforementioned breakable structures may comprise thin-walled portions formed in the connecting projection member.

In the fuel-cell cartridge connector of the invention, the aforementioned thin-walled portions are formed in the circumferential direction of the connecting projection member.

In the fuel-cell cartridge connector of the invention, aforementioned thin-walled portions are formed in the direction of connection to the appliance.

In the fuel-cell cartridge connector of the invention, the aforementioned connecting projection member has at least two or more engagement teeth which are arranged on the end of the outer periphery and on the appliance-connection side of said projection member and which are engageable with an outwardly extending part of the connection portion; said thin-walled portion being formed at the base of the aforementioned engagement teeth.

In the fuel-cell cartridge connector of the invention, the aforementioned connecting projection member has at least two or more engagement teeth which are arranged on the end of the outer periphery and on the appliance-connection side of said projection member and which are engageable with an outwardly extending part of the connection portion; said engagement teeth have chamfered portions formed by chamfering an edge on the side of the fuel-cell cartridge body, said disconnectable structures being the aforementioned chamfered portions.

The fuel-cell cartridge connector of the invention may comprise:

a breakable structure comprising a thin-walled portion formed in the connecting projection member in the direction of connection to the aforementioned appliance, wherein the aforementioned connecting projection member has at least two or more engagement teeth which are located on the end of the periphery of the connecting projection member, project in the outward direction, and are engageable with said connection portion;

a breakable structure comprising a thin-walled portion formed at the base of the aforementioned engagement teeth; and

disconnectable structures comprising chamfered portions of the formed by chamfering the edge of the teeth on the side of the fuel-cell cartridge body.

The fuel-cell cartridge connector of the present invention may comprise:

a breakable structure comprising a thin-walled portion formed in the circumferential direction of the connecting projection member, said connecting projection member having at least two or more engagement teeth which are located on the end of the periphery of the connecting projection member on the side of connection with the appliance; and

a disconnectable structure comprising chamfered portions of the aforementioned teeth formed by chamfering the edge of the teeth on the side of the fuel-cell cartridge body.

Since the fuel-cell-cartridge connector of the present invention is provided with at least one or more structures out of a plurality of such structures which are located in a predetermined position from the fuel container structures and which are breakable from the aforementioned fuel-cell chamber, and out of a plurality of disconnectable structures which can be separated from the connection portion when the connecting projection member is connected to the connection portion so that the fuel-receiving opening communicates with the fuel-receiving opening and when an external force that exceeds a predetermined value, i.e., a force that is beyond the range of forces allowable for normal operation and that can damage the cartridge, is applied to the latter, the connector is either broken or is disengaged from the connection portion of the appliance thus protecting the appliance from damaging. When the connector is broken, breakage occurs at a predetermined distance from the appliance, and this prevents possibility of leakage of fuel from the fuel container.

### DESCRIPTION OF THE PREFERRED EMBODIMENTS

A connector 1 for a fuel-cell cartridge 3 made in accordance with one embodiment of the present invention (hereinafter referred to merely as “connector 1”) will now be described in more detail with reference to the accompanying drawings. FIG. 1 is three-dimensional view of a fuel-cell cartridge 3 equipped with the connector of the present embodiment in a state disconnected from a portable telephone 4 that represents an appliance that contains a fuel cell (a fuel-cell-holding appliance). FIG. 2 is a three-dimensional sectional view of the fuel-cell cartridge 3 shown in FIG. 1. In the subsequent description, the part of the connector 1 of the present embodiment that is to be connected to the portable telephone 4 is the upper part of the device shown in FIGS. 2 and 3.

As shown in FIGS. 1 and 2, the connector 1 of the fuel-cell cartridge 3 of the present embodiment is removably connected by means of a connection mechanism S to a connection portion 2 provided in a portable telephone 4 (FIG. 1) which in this embodiment represents a fuel-cell-holding appliance which contains the fuel cell, such as a direct methanol-type fuel cell (DMFC) (not shown in the drawings), the connector being located on the upper end of the fuel-cell cartridge.

As seen in FIG. 2, the fuel-cell cartridge 3 has a cylindrical container body 31 which is intended to be filled with fuel F and which has a double-container structure that consists of a fuel-receiving inner container 312 having a fuel-receiving chamber 311 separated by a piston 32 and an outer container 313 which is open at the top and intended for receiving a pressurized gas G used for displacement of fuel F by piston 32. A space formed between the outer surface of the inner container 312 and the inner surface of the outer container 313 defines a pressurized-gas chamber 314. The volume ratio between the fuel-receiving chamber 311 and a pressurized-gas chamber 314 depends on the position of the piston 32. When the amount of fuel F is reduced and the piston 32 moves up, a portion of the pressurized-gas chamber 314 is extended toward the fuel-receiving inner container 312.

In accordance with the present embodiment, in order to supply fuel F to the DMFC, methanol is mixed with pure water to form a liquid fuel mixture. However, the invention is not limited to this specific example, and depending on specific requirements, the fuel may comprise a mixture of ethanol and pure water to form alcohol of a predetermined concentration or merely alcohol, etc.

Furthermore, in order to prevent mixing of fuel F with oxygen that adversely affects the reaction that occurs in the fuel cell and in order to protect the fuel from oxidation, it is preferable to use a pressurized gas G that is free of oxygen, such as nitrogen, carbon dioxide, air with oxygen removed therefrom, or the like. Pressurized gas G, which is used in the device of the present embodiment, is a liquefied gas such as dimethylether (DME), although the present invention is not limited to this specific gas.

Fixed to the upper end of the outer container 313 is a connector 1 which is to be attachable to the connection portion 2 (which is described in more detail later) of a fuel-cell-holding appliance. The connector 1 consists essentially of a connector body 11 which is rigidly attached to the outer container 313 and the cartridge-side valve 12 which is rigidly attached to the connector body 11.

The connector body 11 can be made from resin such as polycarbonate (PC) and comprises: a disk-like flange portion 11a which has a central hole; a connecting projection member 11c which extends upward from the flange portion 11a and which has a connection opening 11b; and an inserted portion 11d which has an annular shape, extends downward from the lower outer periphery of the flange portion 11a, and has its outer periphery in contact with the inner surface of the outer container 313. Furthermore, at a certain distance radially inward from the inserted portion 11d, the flange portion 11a has an inner inserted portion 11e which thus forms a double-container structure with the first-mentioned inserted portion 11d and has on its inner surface a thread.

As shown in FIG. 3, the connecting projection member 11c is provided with circumferentially and equally spaced engagement teeth 111 which are made integrally with the connecting projection member 11c on the upper peripheral surface thereof. The connecting projection member 11c is also provided with a pressure shoulder 112 formed on the outer periphery of the lower end thereof. Furthermore, the connecting projection member 11c is provided with a reference tooth 113 which is formed in a predetermined location on the inner periphery and at the upper end of the connecting projection member 11c. This reference tooth 113 is used as a reference point of an absolute reference position and extends downward from the upper end face of the connecting projection member 11c. The connecting projection member 11c is further provided with a plurality of selective teeth (only two of which, i.e., 114 and 115, are shown in the present embodiment) which extend downward from the upper end face and are located in positions preselected with respect to the reference tooth 113, depending on the type of specific fuel-cell cartridge used. The reference tooth 113 of the present embodiment is wider than the selective teeth 114 and 115. Furthermore, depending on the type of fuel-cell cartridge 3 used, selective teeth 114 and 115 may have different widths and lengths in the direction of insertion. Altogether, the reference tooth 113 and selective teeth 114 and 115 form a cartridge-side engagement key K1. At its upper end, the connection opening 11b has a fuel-supply opening 12a for the supply of fuel F and a cartridge-side shut-off valve 12 (described in more detail later) for opening and closing the aforementioned fuel-supply opening 12a.

A specific feature of the present invention is a provision of at least one breakable structure, from a plurality of such structures, which is located at a predetermined distance from the fuel-receiving chamber 311, and at least one disconnectable structure, from a plurality of disconnectable structures, which can be disengaged from the connection portion 2 of the portable telephone 4 when the connecting projection member 11c is connected to the connection portion 2 of the portable telephone 4, so that the fuel-supply opening 12a and the fuel-receiving opening 2a communication with each other, and when an external force that exceeds a predetermined value is applied to the fuel-cell cartridge 3.

As shown in FIG. 3, in connector 1 of the present embodiment, the breakable structure is formed by projection-side thin-walled portions 116 which extend in the vertical direction, i.e., direction of connection of the connecting projection member 11c to the connection portion 2 of the portable telephone 4. Furthermore, a thin-walled portion 111a located on the side of the engagement tooth is formed on the base of the engagement teeth 111, and the aforementioned disconnectable structure is formed by a chamfered portion 111b which is chamfered from the lower edge of each engagement tooth 111.

The projection-side thin-walled portions 116 are located on both sides of the reference tooth 113 and are arranged parallel to the reference tooth 113 in proximity thereto. These thin-walled portions 116 are cut from both the inner periphery and outer periphery of the connecting projection member 11c and have a predetermined wall thickness. The cutouts extend for about 0.5 millimeter downward from the upper end face of the connecting projection member 11c. Furthermore, the thin-walled portions 111a located on the side of the engagement teeth are formed on the outer periphery of the connecting projection member 11c and are formed by making cutouts to a predetermined position in the downward direction from the upper end face of the engagement teeth 111. The chamfered portion 11b of each tooth is formed by the lower end face of the engagement tooth 111 and a chamfered plane that is inclined essentially at 45°. A detailed description of this structure is given below.

The inner container 312 comprises a cylindrical body with an open lower end which, however, does not touch the bottom of the outer container 313. Furthermore, the inner container 312 has on its peripheral surface at the lower end thereof a plurality of longitudinally extending slots 312a so that when the piston 32 performs its downward stroke, the interior of the inner container 312 can still communicate with the interior of the outer container 313. As shown in FIGS. 2 and 3, the inner container 312 has a tubular portion 312c that projects downward from the central part of its upper wall and has a through-opening 312b that communicates with the cartridge-side valve 34. An annular, outwardly flared tubular portion 312d, which is spaced at a predetermined distance in the outward direction, extends from the tubular portion 312c and flares at a certain angle in the outward direction. The aforementioned outwardly flared tubular portion 312d has on its outer surface four connection elements (not shown in the drawings) which extend downward from the lower side of the upper end thereof for engagement with the corresponding inner thread of the inner inserted portion 11e. The outer ends of the aforementioned connection elements are threaded into the inner surface of the inner inserted portion 11e of the connector body 11, and are brought into contact with the connector body 11 when pressure from above is applied to them through a disk-like upper cover 12b.

The cartridge-side valve 12 consists essentially of a housing 121, a stem 122 that is moveable in the vertical direction of the image shown in FIG. 3, a spring 123 that urges the stem 122 in the closing (upward) direction, a valve body 124 (seal ring) that opens or closes the fuel passage, and a connector seal ring 125. The aforementioned fuel-supply opening 12a for the supply of fuel F is formed at the upper end of the cartridge-side valve 12.

The housing 121 has a cylindrical shape and is provided with an annular recess 121a for insertion of the aforementioned upper cover 12b. This annular recess 121a is formed in the lower portion of the housing 121 at a predetermined distance from the central portion of the housing 121 in the vertical direction. The portion of the housing below the aforementioned annular recess 121a has a flared portion 121b2 of a tubular nozzle bottom 121b, and the lower end surface of the flared portion 121b2 contacts a housing spring 126 that surrounds the lower end of the nozzle bottom 121b and is compressed by vertical movement of the nozzle bottom. Furthermore, the housing 121 has a connection seal ring 125 which is inserted into the groove on the outer periphery of the housing 121 near its upper end and is intended for sealing the connection portion 2 of the portable telephone 4, which is described below. The fuel-supply opening 12a formed in the housing 121 extends from the upper end of the housing to a predetermined position in the downward direction, from which position the diameter of this opening in the downward direction is reduced.

The stem 122 comprises a rod-like body which has a large-diameter portion 122a that extends radially outward from the intermediate portion of the stem 122 in the vertical direction, an upper axial portion 122b that extends upward from the large-diameter portion 122a, and a lower axial portion 122c that extends downward from the large-diameter portion 122. The stem 122 also has a small-diameter portion 122d, which is located above the large-diameter portion 122a, and a seal ring 124 that fits onto the stem between the small-diameter portion 122d and the large-diameter portion 122a. The stem 122 is inserted into the housing 121, can move vertically, and is constantly urged upward in the valve-closing direction by a spring 123, which is placed between the lower surface of the large-diameter portion 122 and the upper surface of the nozzle bottom 121b. The end face of the axial portion 122b is intended for insertion into the fuel-receiving opening 12a, and due to contact pressure applied by the spring 123 to the shoulder between the inner surface of the housing 121 and the fuel-supply opening 12a, the valve body 124 closes and thus blocks the passage of fuel F. When the stem 122 is pushed down, the spring 123 is compressed and shifts the stem 122 down, whereby the valve body 124 is separated from the aforementioned shoulder so that the fuel-supply opening 12a is opened and the fuel F can flow through the fuel-supply opening 12a into the fuel-receiving chamber 311.

As shown in FIG. 2, the piston 32 has a resilient seal 32a which is inserted into a groove formed on the outer periphery of the piston 32. This seal functions as a moveable partition that separates the fuel-receiving chamber 311, which comprises a space above the upper surface of the piston 32, from the pressurized-gas chamber so that pressure applied to the lower surface of the piston by the pressurized gas is transmitted to the fuel F by the upper surface of the piston, and when the valve is open, the piston displaces the fuel F.

The following description explains procedures of filling the pressurized-gas chamber 314 with pressurized gas G and supply of fuel F to the fuel-receiving chamber 311. Prior to the supply of fuel to the fuel-receiving chamber 311 the chamber is filled with gas G. First, a gas-supply opening of the pressurized-gas supply device (which is not shown in the drawings) is connected to the cartridge-side valve 12, and pushing on the stem 122 in the valve-opening direction opens the valve 12 through which pressurized gas is injected into the fuel-receiving chamber 311. In response to this, piston 32 is displaced down to the bottom of the outer container 313. In the lowermost position of the piston 32, the upper end of the slot 312a is located above the resilient seal ring 32a, whereby pressurized gas G flows via the slot 312a from the fuel-receiving chamber 311 to the pressurized-gas chamber 314. After the pressure in the pressurized-gas chamber 314 reaches a predetermined value, supply of gas G into this chamber is discontinued.

Next, stem 122 is again moved in the valve-opening direction, whereby an excess of pressurized gas contained in the fuel-receiving chamber 311 is discharged. This causes raise of the piston 32 in the upward direction, and the fuel-receiving chamber 311 is returned to a sealed condition. Now, under the effect of the discharge of the aforementioned excessive pressurized gas, the lower side of the piston 32 will experience pressure of gas G that is contained in the pressurized-gas chamber 314 and will be lifted to the upper end of the fuel-receiving inner container 312, and discharge of the excessive pressurized gas from the fuel-receiving chamber 311 will cause gas to fill the fuel-receiving chamber 311 and the pressurized-gas chamber 314. The fuel-cell cartridge 3 is constructed so that if after the above-described operations the cartridge-side valve 34 is connected to injection means (not shown in the drawings), and injection of the fuel F into the fuel-receiving chamber 311 shifts the piston 32 in the downward direction, the fuel-receiving chamber 311 will be filled with a predetermined amount of fuel F.

The container body 31 of the fuel-cell cartridge 3 of the present embodiment has a double-container structure. However, the container body 31 that incorporates the fuel-cell cartridge connector 1 of the present invention is not limited by this specific structure, and appropriate changes and modifications are possible. For example, the container body may comprise a single container which, along with fuel F, may be filled with liquefied petroleum gas (LPG), dimethylether (DME), chlorofluorocarbon (CFC), or a similar liquefied gas, or pressurized gas such as nitrogen as a spraying agent, whereby under the effect of pressure developed inside the container by the pressurized gas, the fuel can be emitted from the container automatically in the form of a mist or small droplets. Alternatively, the container may be flexible. The use of a recyclable container that can be refillable with fuel F is preferable.

The following description relates to the structure of the connection portion 2 or a portable telephone 4 to which the connector 1 of the aforementioned fuel-cell-cartridge 3 can be removably connected. A three-dimensional bottom view of the connection portion 2 of the portable telephone is shown in FIG. 4. As can be seen from FIG. 4, the connection portion 2 has a fuel-receiving opening 2a that faces to the outside and is intended for receiving fuel F from the above-described fuel-cell cartridge 3. The fuel-receiving opening 2a is connectable to the fuel cell which is not shown in the drawing and which is contained in the portable telephone 4. Furthermore, the fuel-receiving opening 2a receives a rod-like tapered plug 21. When the connection portion 2 is connected to the aforementioned connector 1 of the fuel-cell cartridge 3, the plug 21 pushes the upper end of the stem 122 which is shifted in the valve-opening direction. A valve body, which is not shown in the drawing and which is inserted into the plug 21, is shifted inward by a spring, or the like, and thus maintains the fuel-receiving opening 2a in an open state.

The connection portion 2 is provided with an outwardly projecting connection tubular element 22 that surrounds the fuel-receiving opening 2a and with a connection opening 23 that surrounds the tubular element 22. Guide grooves 23a are formed in the inner surface of the connection opening 23 for guiding the engagement teeth 111 of the above-described connector 1 when the connection portion 2 is connected to the fuel-cell cartridge. The connection portion is also provided with rigid teeth 24a, which extend inward into the connection opening 23, engage the engagement teeth 111, and thus lock the connector 1, and with a flexible lock ring 24 made from polyoxymethylene (POM) or a similar flexible material. Application of pressure to the connecting projection member 11c causes rotation of the lock ring 24, whereby the engagement teeth 111 engage the rigid teeth 24a and lock connector 1 to the connection element 2. Further push on the connecting projection member 11c will again turn the lock ring and cause disengagement of the engagement teeth 111 from the rigid teeth 24a, whereby the connector 1 can be separated from the connection portion 2.

Locking of the connection between the connection portion 2 and the connector 1 is carried out by means of a lock-equipped connector mechanism which is described in Kokai 2006-112635 of an earlier patent application of the same applicant. Therefore, description of this mechanism is omitted from present patent application.

As shown in FIG. 4. the tubular element 22 has on its outer side a reference groove 221, which is located on the side of the connection portion and corresponds to the reference tooth K1 of the aforementioned cartridge-side engagement key 1, and selective grooves 222 and 223, which are located on the side of the connection portion and correspond to the selective teeth 114 and 115. In the illustrated embodiment, the reference groove 221, which is located on the side of the connection portion, is wider than the selective grooves 222 and 223, which are located on the side of the connection portion. Altogether, the reference groove 221 and the selective grooves 222 and 223 form an engagement key K2 which is located on the side of the connection portion.

Although the connection portion 2 and the engagement keys K1 and K2 of the present embodiment have been described with reference to a specific construction, it is understood that the invention is not limited to this specific construction and appropriate changes are possible. For example, a plurality of reference teeth 113 and reference grooves 221 can be used. The reference tooth 113, reference groove 221, selective teeth 114, 115, and selective grooves 222 and 223 can be formed on the inner surfaces, or on both inner and outer surfaces, and may have different arrangement patterns.

For connecting the connector 1 of the fuel-cell cartridge 3 to a connection portion 2, first the tubular element 22 is inserted into the connection opening 11b of the connecting projection member 11c. The reference tooth 113 and selective teeth 114 and 115 of the connector 1, i.e., the cartridge-side engagement key K1, the connection-portion-side reference grooves 221, and connection-portion-side selective grooves 222 and 223, i.e., the connection-portion-side engagement key K2 are engaged, and the tip of the housing 121 (see FIG. 3) is telescopically inserted into the opening of the tubular element 22. After the connection seal ring 345 of the connector 1 comes into contact with the inner surface of the tubular element opening and the connection is reliably sealed, the upper end of the stem 342 applies pressure to the end of the plunger 21, the fuel-receiving opening 2a is opened, and if pressure is further applied from the upper end of the stem 342 to the end of the plunger 21, this action will compress the spring 123, open the cartridge-side valve 12 and thus open the fuel-receiving opening 12a. As a result, fuel F contained in the fuel-cell cartridge 3 will be supplied to the fuel cell (not shown) via the connector 1 and the connection portion 2.

Under the condition described above, only the connector 1 that has the engagement key K1 that corresponds to the connection-portion-side key K2 can be attached to the connection portion 2.

Such construction excludes a possibility of accidentally attaching connector 1 to a wrong fuel cell cartridge that does not have engagement key K1 corresponding to the connection-portion-side engagement key K2, since none of the fuel-cell cartridges can be attached except for one having an engagement key K2 that matches the engagement key K1 of the connector.

Thus, when the connecting projection member 11c is connected to the connection portion 2 and the fuel-supply opening 12a communicates with the fuel-receiving opening 2a, the aforementioned engagement teeth 111 of the connector 1 engage the rigid teeth 24a, whereby the connector 1 is removably attached to the connection portion 2.

As has been described above, the connector 1 of the fuel-cell cartridge 3 of the present embodiment has a breakable structure in the form of projection-side thin-walled portions 116 and tooth-side thin-walled portions 111a and a disconnectable structure in the form of chamfered portions 111b. Therefore, when an external force that exceeds a predetermined value, i.e., a force that is beyond the range of values specified for normal operation or that can damage the cartridge is applied to the fuel-cell cartridge 3, the aforementioned thin-walled structure of the connector 1 is bent, twisted, and breaks at the projection-side thin-walled portions 116 and/or thin-walled portion 111a.

When the connector 1 breaks at the projection-side thin-walled portions 116, the reference tooth 113 can be bent towards the inner side of the connecting projection member 11c. Therefore the outer diameter of the connecting projection member 11c can be reduced, and the connecting projection member 11c, and, hence, the connector 1 can be easily disconnected from the connection portion 2. Since in this case the connector breaks without separation, there is very little possibility that a part of the connector 1 may remains on the side of the connection portion 2. Therefore, there is no need to remove the remaining debris from the connection portion 2, and this prevents damaging the connection portion 2, i.e., the portable telephone 4, by a tool.

When the connector 1 is broken at the tooth-side thin-walled portions 111a, the engagement teeth 111 of the connector 1 are separated from the remaining main part of the connector. Since in this case the engagement teeth 111, which are engaged with the rigid teeth 24a, are separated from the main part of the connector 1, the aforementioned main part is disengaged from the connection portion 2, whereby the main part of the connector 1 can be separated from the connection portion 2. Even if the engagement teeth 111 remain inside the connection portion 2, they can be easily removed from the connection portion 2 since they are relatively small as compared to the connector 1 and the connection portion 2.

Even though the connector 1 can be broken as described above, the fuel F that is contained in the fuel-receiving chamber 311 will not leak to the outside because the projection-side thin-walled portions 116 and the thin-walled portions 111a are spaced to a predetermined distance from the fuel-receiving chamber 311, and therefore the connector 1 will be broken in a position remote from the fuel-receiving chamber.

If the applied force is a stretching force P, then, as shown in FIG. 5, the engagement teeth 111 will be guided along their chamfered portions 111b, and the rigid teeth 24a will be urged in the outward downward direction. In this case, the rigid teeth 24a will deform the lock ring 24, which, as mentioned above, possess plasticity. Therefore, a compression force applied to the lock ring 24 will deform the lock ring 24 by extending it downward in the direction of the bending force. This will disengage the engagement teeth 111 from the rigid teeth 24a and will allow disconnection of the connector 1, i.e., the fuel-cell cartridge 3, from the connection portion. When the connector 1 is separated from the connection portion 2, the lock ring 24 restores its original shape. In this case, the connector 1 can be separated without breakage and can be reused with the fuel-cell cartridge 3.

As has been shown above, since the connector 1 either breaks or separates from the connection portion 2 of the portable telephone 4, the connection portion 2, i.e., the portable telephone will be protected from damage when a force that exceeds allowable range is applied to the fuel-cell cartridge.

According to the data taken from a non-patent literature source entitled “Ergonomics Manual of Standard Numerical Formulae” (Gihodo Publishers), the following maximum forces can be developed by humans hands: a 20 mm cylinder grasped with fingers can be twisted with the maximum torque of 110 N·cm; a moment developed by fingers pushing the object with the force of 102 N applied at 50 mm from the fulcrum point reaches 510 N·cm; a pulling force that can be developed by fingers that pulls a rod of a 15-mm-side rectangular cross section is 60 N.

If in the case of the above-described cartridge, the outer diameter of the container body 31 is 20 mm, the length of the fuel-cell cartridge in the longitudinal direction is 50 mm, the fuel capacity is 5 mL, and the weight of the cartridge 3 filled with fuel F is 18 g, then forces applied to the connector 1 under normal operation conditions will be the following: twisting torque 55 N·cm; bending moment 7.1 N·cm; and pulling force 30 N.

Thus, in the case of the above-described fuel-cell cartridge 3, the twisting torque that may exceed the aforementioned predetermined value may be greater than 55 N·cm but lower than 110 N·cm; a bending moment torque that can exceed the aforementioned predetermined value may be greater than 7.1 N·cm but lower than 510 N·cm; and the pulling force that can exceed the aforementioned predetermined value may be greater than 30 N·cm but lower than 60 N·cm.

Although in the connector 1 of the present embodiment of the invention the breakable structure was shows with reference to the specific projection-side thin-walled portions 116 and the thin-walled portions 111a, and the disconnectable structure was shows with reference to specific chamfered portions 111b, the fuel-cartridge connector of the invention is not limited to the above-described example, and appropriate changes and modifications are possible. For example, the connector may have only projection-side thin-walled portions 116, only thin-walled portions 111a, or only chamfered portions 111b, a combination of the projection-side thin-walled portions 116 and the thin-walled portions 111a, a combination of projection-side thin-walled portions 116 and the chamfered portions 111b, or a combination of thin-walled portions 111a and chamfered portions 111b.

The following description will relate to another embodiment of a fuel-cell cartridge connector 1′ which is shown on a larger scale in FIG. 6 in the form of a three-dimensional view. Since, except for the breakable structure and the disconnectable structure, the connector 1′ of this embodiment has the same parts as the connector of the present embodiment, these parts are designated by the same reference numerals and their description is omitted. For the same reason, explanation will relate only to breakable and disconnectable structures.

As shown in FIG. 6, the connector 1′ has a breakable structure in the form of a projection-side thin-walled portion 117 arranged in the circumferential direction of the connecting projection member 11c and a disconnectable structure in the form of chamfered portions on the lower edges of the engagement teeth 111.

The projection-side thin-walled portion 117 is formed in the outer peripheral surface of the connecting projection member 11c in a position spaced for a predetermined distance up from the upper surface of the disk-like flange portion 11a and comprises an annular groove cut in the outer periphery of the connecting projection member 11c thinning its wall to a predetermined thickness. The chamfered portion 11b comprises a skewed surface inclined at an angle of 45° to the lower edge of the engagement tooth 111.

As has been described above, the connector 1′ of the fuel-cell cartridge 3 of the present embodiment has a breakable structure in the form of projection-side thin-walled portions 11 and a disconnectable structure in the form of chamfered portions 111b. Therefore, when an external force that exceeds a predetermined value, i.e., a force that is beyond the range of values specified for normal operation or that can damage the cartridge is applied to the fuel-cell cartridge 3, the aforementioned thin-walled structure of the connector 1′ is bent, twisted, and breaks at the projection-side thin-walled portions 117.

When the connector 1′ breaks at the projection-side thin-walled portions 117, the connection-portion side of the connector that contains the engagement teeth 111 is separated at the broken thin-walled portion 117 from the side of the container body 31. As a result, the fuel-cell cartridge 3 that has teeth 111 in a disengaged state can be separated from the connection portion 2. Since in this case the part of the connector body 11 on the side of the connection portion 2 that contains the engagement teeth remains on the connection portion 2 with the teeth 111 engaged as they are with the rigid teeth 24a and since the remaining part of the connector body 11 is small, the remaining position thereof stays inside the connection portion and cannot be easily separated from the connection portion 2. In order to remove the aforementioned remaining part of the connector body 11, the aforementioned predetermined distance in which the thin-walled portion 117 is formed at the lower end of the 11c connecting projection member 11c, so that by pushing the remaining part of the connector body 11 into the connection portion 2, it will be possible to turn the lock ring 24, disengage the engagement teeth 111 from the rigid teeth 24a, and then easily remove the remaining part of the connector body 11.

Furthermore, when an external pulling force P is applied, then, as shown in FIG. 5, similar to the previous embodiment, the engagement teeth 111 are guided along the inclined surfaces formed by their chamfered portions 111b and deform the rigid teeth 24a, whereby the engagement teeth 111 are disengaged from the rigid teeth 24a, and the connector 1′, e.g., the fuel-cell cartridge 3, can be separated from the connection portion.

Since, as has been explained above, the connector 1′ breaks or is disengaged from the connection portion 2 of the portable telephone 4, the connection portion 2, i.e., the portable telephone 4, will be protected from damage when a force that exceeds allowable range is applied to the fuel-cell cartridge.

Although in the connector 1′ of the present embodiment of the invention the breakable structure was shows with reference to the specific projection-side thin-walled portions 117, and the disconnectable structure was shows with reference to specific chamfered portions 111b, the fuel-cartridge connector of the invention is not limited to the above-described examples, and appropriate changes and modifications are possible. For example, the connector may selectively have only projection-side thin-walled portions 117, or only thin-walled portions 111a.

Although the fuel-cell cartridge connectors 1 and 1′ of the aforementioned embodiments were described as connectors for removable attachment to the connection portion 2 of a fuel-cell-holding device in the form of a portable telephone, the invention is not limited by this specific application, and the same connectors can be used for note books, personal computers, or to any other appliances that contain fuel cells having connection portions that match connectors 1, 1′.

Although the fuel-cell cartridge connectors 1 and 1′ of the aforementioned embodiments are formed by combining the above-described breakable and/or disconnectable structures, the fuel-cell cartridge connectors of the invention are not limited by the illustrated examples, and can be formed by other appropriately selected combinations.

### BRIEF DESCRIPTION OF THE DRAWINGS

FIG. 1 is three-dimensional view of a fuel-cell cartridge equipped with a connector according to an embodiment of the invention in a state disconnected from a portable telephone that contains the fuel cell.

FIG. 2 is a three-dimensional sectional view of the fuel-cell cartridge 3 shown in FIG. 1.

FIG. 3 is a three-dimensional sectional view of the fuel-cell cartridge connector of FIG. 2 shown on a larger scale.

FIG. 4 is an enlarged three-dimensional view of the connection portion of the portable telephone.

FIG. 5 is an enlarged view of an engagement tooth and a rigid tooth.

FIG. 6 is an enlarged view of a connector according to another embodiment of the invention.

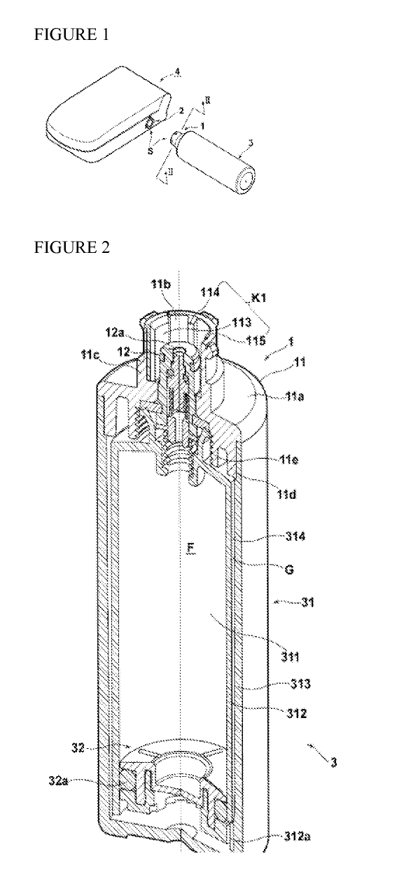

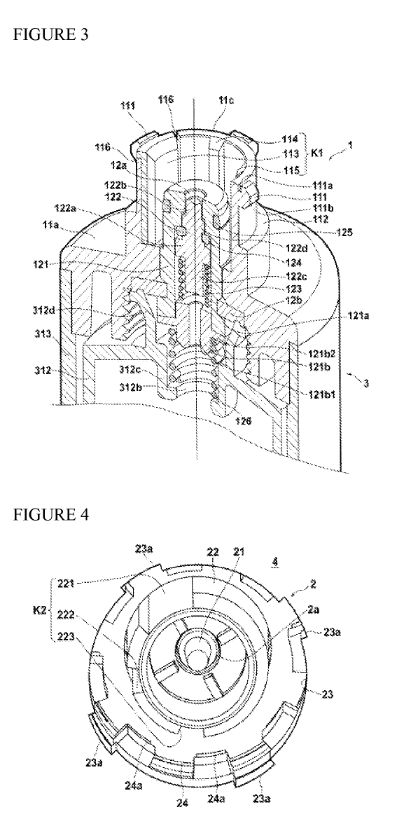

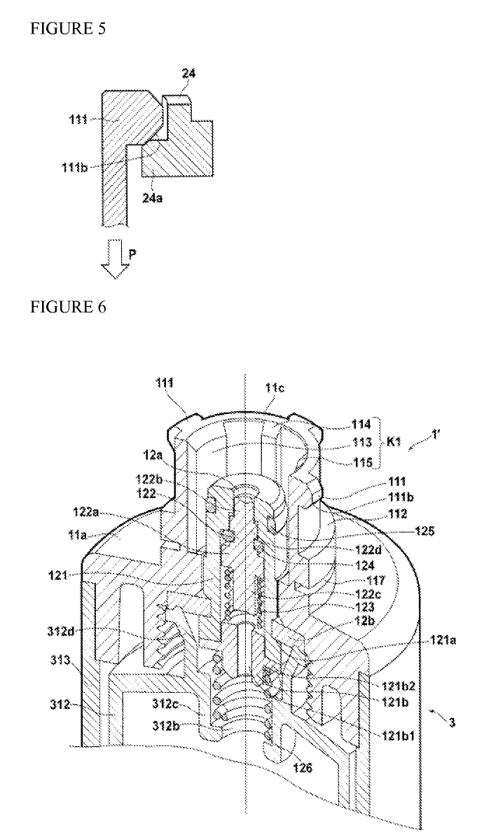

### FIGURE LEGEND

1, 1′ fuel-cell cartridge connector

11 connector body

11c connecting projection

111 engagement teeth

111a tooth-side thin-walled portions (breakable structure)

111b chamfered portions (disconnectable structure)

116 projection-side thin-walled portions

117 thin-walled portion arranged in the circumferential direction

12 cartridge-side valve

12a fuel-supply opening

2 connection portion

2a fuel-receiving opening

3 fuel-cell cartridge

31 container body (fuel-cell cartridge body)

311 fuel-receiving chamber

4 portable telephone (fuel-cell-holding appliance)

F fuel

K1 connector-side engagement key

K2 connection-portion-side engagement key

What is claimed is:

1. A fuel-cell connector comprising:
an outwardly facing fuel supply opening provided on one end of a fuel-cell cartridge body that has a fuel-cell chamber for containing a fuel to be supplied to the fuel-cell cartridge and a connecting projection member that surrounds the aforementioned fuel-supply opening; said fuel cell connector being intended for releasable connection to an appliance that contains the fuel cell, has an outwardly facing fuel-receiving opening for receiving fuel, and has a connection portion that corresponds to the aforementioned connecting projection member, the fuel-cell connector being characterized by a provision of at least one or more structures out of a plurality of such structures which are breakable from the aforementioned fuel-cell chamber at a predetermined distance therefrom and out of a plurality of disconnectable structures which can be separated from the connection portion when the connecting projection member is connected to the connection portion so that the fuel-receiving opening communicates with the fuel-receiving opening and when an external force that exceeds a predetermined value is applied to the fuel-cell cartridge.

2. The fuel-cell cartridge connector of claim 1, wherein the aforementioned breakable structures are thin-walled portions formed in the connecting projection member.

3. The fuel-cell cartridge connector of claim 2, wherein the aforementioned thin-walled portions are formed in the circumferential direction of the connecting projection member.

4. The fuel-cell cartridge connector of claim 2, wherein the aforementioned thin-walled portions are formed in the direction of connection to the appliance.

5. The fuel-cell cartridge connector of claim 2, wherein the aforementioned connecting projection member has at least two or more engagement teeth which are arranged on the end of the outer periphery and on the appliance-connection side of said projection member and which are engageable with an outwardly extending part of the connection portion; said thin-walled portion being formed at the base of the aforementioned engagement teeth.

6. The fuel-cell cartridge connector of claim 1, wherein the aforementioned connecting projection member has at least two or more engagement teeth which are arranged on the end of the outer periphery and on the appliance-connection side of said projection member and which are engageable with an outwardly extending part of the connection portion; said engagement teeth have chamfered portions formed by chamfering an edge on the side of the fuel-cell cartridge body, said disconnectable structures being the aforementioned chamfered portions.

7. The fuel-cell cartridge connector of claim 1, comprising:
a breakable structure comprising a thin-walled portion formed in the connecting projection member in the direction of connection to the aforementioned appliance, wherein the aforementioned connecting projection member has at least two or more engagement teeth which are located on the end of the periphery of the connecting projection member, project in the outward direction, and are engageable with said connection portion;
a breakable structure comprising a thin-walled portion formed at the base of the aforementioned engagement teeth; and
disconnectable structures comprising chamfered portions formed by chamfering the edge of the teeth on the side of the fuel-cell cartridge body.

8. The fuel-cell cartridge connector of claim 1, comprising:
a breakable structure comprising a thin-walled portion formed in the circumferential direction of the connecting projection member, said connecting projection member having at least two or more engagement teeth which are located on the end of the periphery of the connecting projection member on the side of connection with the appliance; and
a disconnectable structure comprising chamfered portions of the aforementioned teeth formed by chamfering the edge of the teeth on the side of the fuel-cell cartridge body.
